(19) United States
(12) Patent Application Publication
(10) Pub. No.: US 2026/0311456 A1
(43) Pub. Date: Oct. 8, 2026

(54) Vision-Language Model-Based System and Method for End-to-End Construction Hazard Identification and Report Generation

(71) Applicant: City University of Hong Kong, Hong Kong (HK)

(72) Inventors: Xianfei YIN, Hong Kong (HK); Qihua CHEN, Hong Kong (HK)

(21) Appl. No.: 19/359,697

(22) Filed: Oct. 16, 2025

Related U.S. Application Data
(60) Provisional application No. 63/782,616, filed on Apr. 3, 2025.

(51) Int. Cl. G06V 10/764; G06F 40/40; G06Q 50/08; G06V 10/774; G06V 10/776; G06V 20/40

(52) U.S. Cl. CPC G06V 10/764; G06F 40/40; G06Q 50/08; G06V 10/774; G06V 10/776; G06V 20/46

(57) ABSTRACT

The present invention provides vision-language model (VLM)-based system and method for end-to-end construction hazard identification and report generation. The method comprises: preparing construction hazard dataset for training and evaluation; utilizing the prepared training dataset to fine-tune a pretrained VLM to obtain a VLM-empowered construction hazard identifier; identifying, by the VLM-empowered construction hazard identifier, one or more hazards in a construction site; and generate, by a large language model, an end-to-end real-time construction hazard report based on the identified construction hazards. Evaluation results demonstrated that the VLM-empowered construction hazard identifier outperforms both advanced and traditional pre-trained VLMs while exhibiting strong robustness and few-shot learning capabilities. Applications of the present invention in real construction projects show that it can generate organized and accurate hazard reports.

### CROSS-REFERENCE TO RELATED APPLICATIONS

The present application claims priority from the U.S. Provisional Patent Application No. 63/782,616 filed Apr. 3, 2025, and the disclosure of which is incorporated herein by reference in its entirety.

### FIELD OF THE INVENTION

The present invention generally relates to engineering management technology, and more specifically, relates to vision-language model (VLM)-based method and system for automated end-to-end construction hazard identification and report generation.

### BACKGROUND OF THE INVENTION

The construction industry has long been acknowledged as one of the most risky industries [1,2]. According to statistical data, it was responsible for 21.16% of all fatal workplace accidents in the United States in 2020 [3]. These accidents are predominantly attributed to a myriad of hazards inherent in construction environments [4]. Research has indicated that approximately 80% of construction-related accidents can be traced back to worker's unsafe behaviors [5,6]. To reduce these hazards, traditional Behavior-Based Safety (BBS) approaches have emphasized manual inspections coupled with immediate corrective actions [7], which have been deemed effective management practices [3]. However, this method is characterized by inefficiency, susceptibility to human error, and a lack of continuous monitoring capability [8,9]. In recent years, advancements in computer vision (CV) technology, along with the deployment of sophisticated construction site monitoring systems, have mitigated some limitations associated with manual inspections [10-12]. Nevertheless, previous solutions typically only identified a limited range of common construction hazards and relied on intricate rule-based decision-making processes. Furthermore, since the supervised learning paradigm for model training relies exclusively on labeled datasets, it imposes significant limitations on model generalization and impairs adaptability to unseen, complex, dynamic construction scenarios [9,14]. Therefore, there is an urgent need for a framework that leverages advanced scene understanding and perception technologies to achieve precise and comprehensive identification of various types of construction hazards. Table 1 summarizes past research efforts that utilized CV for identifying diverse construction hazards.

TABLE 1
Previous research on construction hazard identification using CV techniques.

| Types | Construction hazard |
|---|---|
| Wear PPE | Helmet inspection[45]; Incorrect usage of safety helmets and harness |
| | hooks [46]; 6 types of construction PPE wear violation detection[9]; 8 |
| | types of PPE violation detection [41] |
| Worker Behavior | Workers entering hazardous areas [12]; Workers enter the excavator's |
| | operating area [47]; Workers climbing guardrail[42]; Smoking [43] |
| Environment | Inspection of floor openings [44]; Fire monitoring[48]; Cluttered |
| | construction housekeeping [49]; Water leakage identification[50]; |
| | Safety guardrail compliance inspection [51] |

A crucial capability for achieving these goals is a comprehensive and in-depth understanding of construction scenarios, coupled with advanced reasoning to identify construction hazards. In recent years, significant progress has been made in the research on Vision-Language Models (VLMs) [15]. VLMs are defined as a class of AI models that integrate CV and natural language processing techniques to achieve a holistic understanding of both visual and textual information. Consequently, VLMs possess a unique combination of visual comprehension, human-like world knowledge, and robust reasoning abilities. Notable examples include CLIP [16] and BLIP [17]. Compared to traditional CV methods, VLMs exhibit superior robustness and generalization when handling complex scenes [18]. Additionally, the self-supervised learning mechanism of VLMs allows them to acquire knowledge from unlabeled data, thereby reducing reliance on manually annotated datasets [19,20]. Within the construction domain, Liang et al. [21] developed few-shot learning algorithms using CLIP for recognizing temporary construction site objects. Tsai et al. combined CLIP with GPT-2 for safety hazard inspections. Chen et al. [22] integrated CLIP with 3D-based ResNet for excavator activity recognition within limited datasets. Yong et al. [23] utilized BLIP along with data augmentation techniques to identify ergonomic issues. Despite these advancements, past approaches still face several challenges in construction hazard identification. First, they fail to provide end-to-end outputs of construction hazard categories, such as extracting the presence of hazards directly from construction videos and generating reports [24]. Second, construction sites present a wide variety of complex hazards, including unguarded rotating machinery parts and haphazardly stacked materials, which necessitate more specific and granular hazard identification capabilities. Finally, traditional VLMs like CLIP have limitations in semantic understanding of complex scenarios and input image size [25], underscoring the need to explore and apply more advanced VLMs to address these challenges.

More advanced VLMs, such as GPT-4o[26], LLaVA [27], and Qwen2-VL [28], have demonstrated enhanced image and text understanding capabilities. Meanwhile, the new learning paradigm of “pre-training, fine-tuning (a process known as transfer learning), and prediction” has demonstrated remarkable performance in various domain-specific visual understanding tasks [20]. For instance, this framework has been successfully applied to real-time hazard description in autonomous driving systems [29] and industrial anomaly detection [30].

Despite these advancements, significant challenges remain in applying advanced VLMs to construction site hazard identification. VLMs excel in open-world understanding, but it is imperative to develop specialized VLMs tailored for construction hazard identification to meet the stringent accuracy requirements of construction safety management. Specifically, while certain tools, equipment, and usage protocols in construction environments may share similarities with those in general contexts, subtle differences can significantly influence the VLM's assessment of construction hazards. This highlights the necessity for developing specialized VLMs dedicated to construction hazard identification. Moreover, the design of well-designed prompts for VLM fine-tuning and the utilization of multi-source video data for automated construction hazard reporting remain under-explored areas that warrant further study.

Limited efforts have been devoted to comprehensive construction hazard identification and automated report generation. The two significant research gaps identified are presented as follows:

Inadequate capabilities for fine-grained and end-to-end construction hazard identification. Existing CV-based methods primarily focus on detecting specific hazards (e.g., PPE violations or worker behaviors) but lack the ability to simultaneously identify diverse hazard categories in complex construction environments. Furthermore, prior studies heavily rely on rule-based decision-making and labeled datasets, which restrict model adaptability to unseen or dynamic construction scenes. Additionally, traditional VLMs exhibit limitations in semantically understanding construction-specific scenarios and struggle to directly output hazard categories from visual data. While advanced VLMs show promise, their open-world training paradigms lack specialized capabilities tailored to construction safety contexts, resulting in insufficient accuracy for critical hazard identification.

Limited practicality in automated hazard report generation from multi-source video data. Current approaches for generating construction hazard reports depend on manual verification of hazard categories or isolated image analysis, hindering real-time and scalable safety management. Moreover, existing frameworks do not adequately address the processing of continuous multi-source video streams, extraction of contextually relevant hazards, or generation of structured reports without human intervention. Additionally, the integration of construction hazard identification VLMs with prompt engineering techniques for report generation remains underexplored, particularly in handling the dynamic nature of construction sites and ensuring practical applicability in output quality.

### SUMMARY OF THE INVENTION

To fill the above gaps, the present invention proposes an innovative framework: an advanced VLM-empowered construction hazard identifier, ChatCH, and an end-to-end method for generating construction hazard reports.

In accordance with one aspect of the present invention, provided is a vision-language model (VLM)-based system for end-to-end construction hazard identification and report generation comprising: one or more processors; a VLM-empowered construction hazard identifier supported by the one or more processors and specialized in construction hazard identification; and a large language model (LLM) supported by the one or more processors and specialized in construction hazard report generation; one or more memory devices inter-operably coupled with the one or more processors and storing one or more instructions that, when executed by the one or more processors, causes: the VLM-empowered construction hazard identifier to autonomously identify one or more construction hazards in a construction site; and the LLM to generate an end-to-end real-time construction hazard report based on the identified construction hazards; wherein the VLM-empowered construction hazard identifier is obtained by: constructing a plurality of image-text pairs relevant to construction hazards; designing a plurality of label-alignment prompts based on the image-text pairs; establishing a construction hazard dataset by associating (or matching) the image-text pairs with the corresponding label-alignment prompts; fine-tuning a plurality of general VLMs using the construction hazard dataset; selecting a best-performing fine-tuned VLM to be the VLM-empowered construction hazard identifier.

Preferably, the plurality of image-text pairs relevant to construction hazards are constructed by: systematically categorizing a plurality of common construction hazards based on at least one of past literature and practical experience to establish a construction hazard checklist; collecting a plurality of images from construction sites featuring various hazard characteristics; classifying the plurality of collected images according to the construction hazard checklist to align each image with one or more construction hazard categories; and associating (or matching) each classified image with a corresponding textual description confirming that the image represents at least one construction hazard category to form the plurality of image-text pairs.

Preferably, the plurality of common construction hazards is categorized into four major categories: Personal Protective Equipment (PPE), worker behavior, tools and equipment, and environment.

Preferably, the plurality of label-alignment prompts is designed by: defining a role and expertise of the VLMs to be fine-tuned as an expert in recognizing construction site hazards; specifying input information and output requirements for the VLMs; and listing a plurality of hazard categories according to classified images associated with a plurality of image-text pairs.

Preferably, the general vision-language models (VLMs) have different parameter sizes; and each of the general VLMs is fine-tuned using a low-rank adaption technique without altering parameters of the general VLM.

Preferably, each of the fine-tuned VLMs is evaluated by: using the fine-tuned VLM to infer outputs on an evaluation dataset; obtaining alignment results between the inferred outputs with hazard labels; and calculating evaluation metrics on the obtained alignment results.

Preferably, the one or more processors are configured to: receive real-time video footage of the construction site; extract a plurality of image frames from the real-time video footage; and input the plurality of image frames into the VLM-empowered construction hazard identifier; and the VLM-empowered construction hazard identifier is configured to identify the one or more construction hazards in the plurality of image frames; the one or more processors are further configured to determine the identified hazards corresponding to each point in time and location in the construction site; and the large language model is configured to: compile all of the identified hazards over a specific period of time; and generate the real-time construction hazard report for the construction site over the specific period of time based on the compiled identified hazards.

Preferably, the plurality of image frames is extracted from the real-time video footage through capturing image frames from the real-time video footage at predetermined time intervals; and associating (or matching) each captured image frame with a corresponding position and capture time.

Preferably, the one or more construction hazards are identified in the plurality of image frames by: sequentially reading the plurality of image frames; recording the plurality of image frames in a database; and documenting a hazard record for each of the plurality of image frames, wherein the hazard record comprising a location and a timestamp associated with the image frame.

Preferably, the construction hazard report is generated over the specific period of time by: designing a plurality of report-generation prompts for organizing construction hazard identification results across all locations over the specific period of time, the report-generation prompts including data formats, source explanations, output formats, and considerations for ignoring occasional hazards in a time series; reading, using the report-generation prompts, a specified length of construction hazard record data from a database, the specified length being determined based on a maximum number of tokens processable by the large language model (LLM); storing output results generated by the LLM in the database; repeating the reading and storing steps until all hazard records in the database are organized; reading, using the report-generation prompts, segmented construction hazard organization results from the database; and generating the construction hazard report based on the segmented construction hazard organization results.

In accordance with another aspect of the present invention, provided is a vision-language model (VLM)-based method for end-to-end construction hazard identification and report generation comprising: identifying, by a VLM-empowered construction hazard identifier, one or more hazards in a construction site; and generating, by a large language model, an end-to-end real-time construction hazard report based on the identified construction hazards; wherein the VLM-empowered construction hazard identifier is obtained by: constructing a plurality of image-text pairs relevant to construction hazards; designing a plurality of label-alignment prompts based on the image-text pairs; establishing a construction hazard dataset by associating (or matching) the image-text pairs with the corresponding label-alignment prompts; fine-tuning a plurality of general VLMs using the construction hazard dataset; selecting a best-performing fine-tuned VLM to be the VLM-empowered construction hazard identifier.

The main contributions of the present invention are as follows: the advanced VLM-empowered construction hazard identifier, ChatCH, can comprehensively and precisely identify construction hazards by leveraging image-text pairs of construction hazards. The Construction Hazard Dataset (CHD), consisting of 1,308 real construction site images across 32 fine-grained construction hazard categories, is constructed to serve as a robust benchmark for training and evaluating model performance in construction hazard identification.

ChatCH was compared with advanced pre-trained VLMs (Qwen2-VL, LLaVA1.5) and traditional pre-trained VLMs (CLIP, Blip) based on the CHD. The results demonstrate that ChatCH outperforms both advanced and traditional pre-trained VLMs while exhibiting strong robustness and few-shot learning capabilities. Applications of the end-to-end construction hazard report generation method using ChatCH in real construction projects show that it can generate high quality, organized and accurate hazard reports.

### BRIEF DESCRIPTION OF THE DRAWINGS

Embodiments of the invention are described in more details hereinafter with reference to the drawings, in which:

FIG. 1 illustrates the key steps for construction hazard identification in accordance with an embodiment of the present invention.

FIG. 2A illustrates a block diagram of an artificial intelligent (AI) system for construction hazard identification and report generation in accordance with one embodiment of the present invention.

FIG. 2B illustrates the overall framework of the present invention.

FIG. 3 illustrates Low-Rank Adaptation (LoRA) within Transformer architecture.

FIG. 4 illustrates structured output parser prompt and process.

FIG. 5 illustrates LLM prompt for generating construction hazard reports.

FIG. 6 illustrates examples of construction hazards and corresponding labels.

FIG. 7 illustrates count of each label in the test and train set.

FIG. 8 illustrates prompts composition for constructing UPD and CPD datasets.

FIG. 9 illustrates the .json file of the UPD dataset.

FIG. 10 illustrates original image and images after fogging and low-light processing.

FIG. 11A to 11F illustrate performance and loss curves of ChatCH. FIG. 11A: Results of ChatCH using Qwen2-VL-2B on CPD, FIG. 11B: Results of ChatCH using Qwen2-VL-7B on CPD, FIG. 11C: Results of ChatCH using LLaVA1.5-7B on CPD, FIG. 11D: Results of ChatCH using Qwen2-VL-2B on UPD, FIG. 11E: Results of ChatCH using Qwen2-VL-7B on UPD, and FIG. 11F: Results of ChatCH using LLaVA1.5-7B on UPD.

FIGS. 12A and 12B illustrate performance and loss curves of fine-tuned CLIP and Blip, respectively.

FIGS. 13A and 13B illustrates performance of each category of construction hazards identified before and after fine-tuning. FIG. 13A illustrates performance of the pre-trained Qwen2 VL 7B model without fine-tuning. FIG. 13B illustrates performance of the pre-trained Qwen2 VL 7B Model after fine-tuning (results for 12th epoch on the CPD dataset).

FIG. 14 illustrates example of construction hazard identification results from ChatCH output after label alignment (i.e., after structured output parser) at different construction locations.

FIG. 15 illustrates results of end-to-end generated construction hazard reports.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

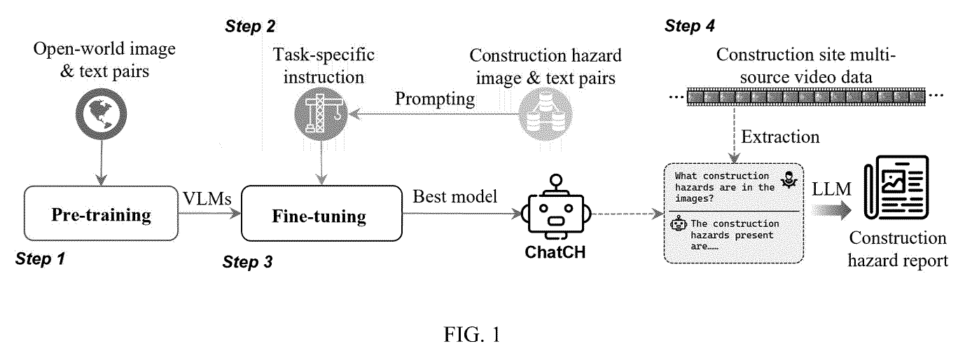

FIG. 1 illustrates key steps for construction hazard identification and report generation in accordance with one embodiment of the present invention. Step 1 involves selecting a pre-trained VLM that has been trained on a large corpus of open-world image-text pairs, equipping it with a strong semantic understanding of open-world images. Step 2 entails constructing specific image-text pairs relevant to construction hazards and designing the dataset along with prompt design for fine-tuning the pre-trained VLMs. Step 3 employs the pre-trained VLMs from Step 1 and the construction hazard dataset from Step 2 for fine-tuning using the parameter-efficient fine-tuning (PEFT) [31] technique to obtain an advanced VLM-empowered construction hazard identifier, ChatCH, which can effectively recognize various construction hazards while maintaining the capabilities of the underlying pre-trained VLM. Step 4 involves extracting images from multi-source construction site videos and using ChatCH to identify construction hazards, ultimately generating detailed construction hazard reports through prompt engineering techniques. This process facilitates the specific task of construction hazard identification using VLMs and supports the automatic generation of construction hazard reports, thereby providing robust support for automated construction hazard inspection.

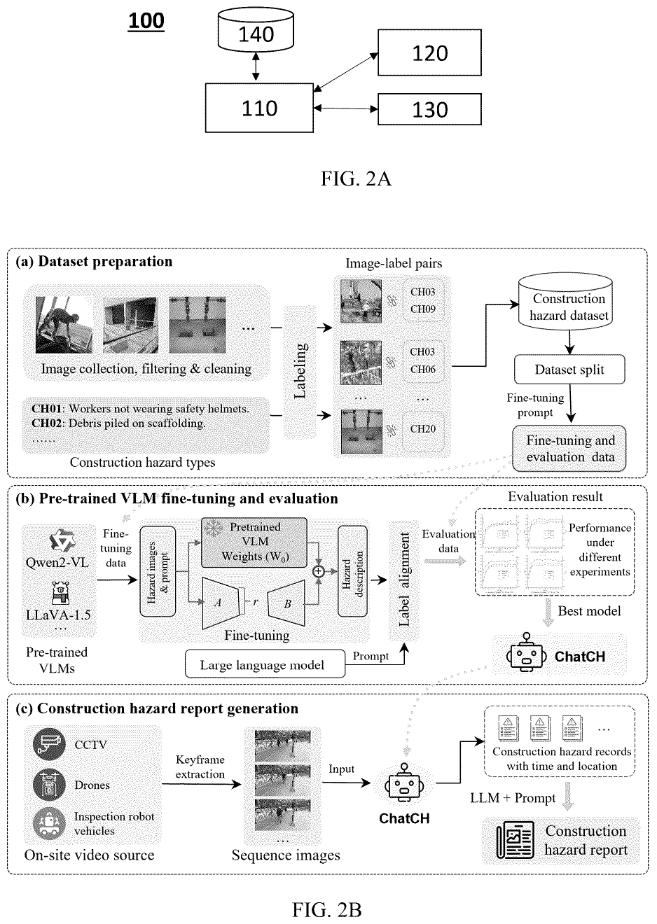

FIG. 2A shows a block diagram of vision-language model (VLM)-based system 100 for construction hazard identification and report generation in accordance with one embodiment of the present invention. The VLM-based system comprises: one or more processors 110; a VLM-empowered construction hazard identifier 120 supported by the one or more processors and specialized in construction hazard identification; a large language model (LLM) 130 supported by the one or more processors and specialized in construction hazard report generation; and one or more memory devices 140 inter-operably coupled with the one or more processors and storing one or more instructions that, when executed by the one or more processors, causes: the VLM-empowered construction hazard identifier 120 to autonomously identify one or more construction hazards in a construction site; and the LLM 130 to generate an end-to-end real-time construction hazard report based on the identified construction hazards.

FIG. 2B presents the framework implemented by the VLM-based system for monitoring hazard in construction sites and generating construction hazard reports. The framework comprises three key stages: dataset preparation, fine-tuning stage and practical application.

In the initial dataset preparation stage, the inventors identify typical construction site hazards and collect, filter, and clean images containing these hazards, the inventors then label the images to create image-hazard pairs, divide the dataset into training and validation sets, and design prompts for training the ChatCH model.

In the fine-tuning stage, the inventors leverage advanced pre-trained VLMs along with fine-tuning techniques to adapt the VLMs specifically for identifying construction hazards using fine-tuning data. The fine-tuned VLM's outputs are aligned with labels through a designed LLM prompt to ensure accurate evaluation of the model's hazard identification performance on evaluation data. Subsequently, the model's efficacy is assessed using standard evaluation metrics to identify the optimal ChatCH model for construction hazard identification.

During the practical application stage, the focus shifts to generating automatic construction hazard reports. This involves extracting keyframes from multi-source videos and inputting the resulting sequence of images into ChatCH for hazard identification. Construction hazard reports are then automatically generated using designed LLM prompts.

In BBS construction risk assessment, hazards encompass not only workers' use of PPE and unsafe behaviors but also the status of tools/equipment and environmental conditions. This study systematically categorizes common construction hazards into four primary types—PPE, worker behavior, tools/equipment, and environment—based on the frameworks proposed by Chen et al. [3] and Lee et al. [58], combined with a review of CV-based hazard identification studies (see Table 1) and insights from on-site inspections. Specifically, all visually identifiable hazard categories falling under these four primary types can included in the categorization. As shown in FIG. 2A, a high-quality CHD was assembled by collecting images of diverse hazards from real construction sites. Manual classification ensured alignment with predefined hazard categories, guaranteeing that each image represented at least one hazard type. Subsequently, all hazard images were manually annotated to generate image-text pairs, culminating in the final CHD dataset. Randomly selected samples from the CHD dataset were used to evaluate ChatCH's performance.

To fine-tune the VLM, a three-part prompt structure was designed: System, Human, and Identifier. The System component defines the model's role as an expert in construction hazard identification, ensuring focused responses. The Human component simulates user queries by providing input requirements and expected outputs. The Identifier component generates responses listing identified hazard categories based on input images. This structured interaction process efficiently fine-tunes the pre-trained VLM for construction hazard identification tasks. Using Python scripts, json files for fine-tuning and evaluation were automatically generated based on the designed prompts and image-text pairs in the CHD dataset.

Pre-trained VLMs serve as general-purpose model for visual and linguistic understanding, initially pre-trained on extensive and varied datasets. These models are subsequently refined with specialized labeled data pertinent to specific tasks or domains, enhancing both their specialized performance and adaptability to the target domain [59]. This process aligns with transfer learning principles and offers significant advantages for domain-specific task optimization [60]. Given the substantial parameter count in pre-trained models, full fine-tuning demands considerable computational resources and memory [61]. PEFT techniques mitigate the memory overhead associated with refining pre-trained VLMs, facilitating adaptation in environments with limited resources. Moreover, PEFT technique freezes the weights of the pre-trained VLM during the training process, ensuring it does not directly participate in the model training, thereby avoiding catastrophic forgetting [62]. Notably, in PEFT techniques, the Low-Rank Adaptation (LoRA) [31] offers an efficient solution to challenges such as overfitting and catastrophic forgetting encountered in traditional fine-tuning methods. Furthermore, LoRA maintains inference efficiency by avoiding additional latency during task-specific adaptation [63].

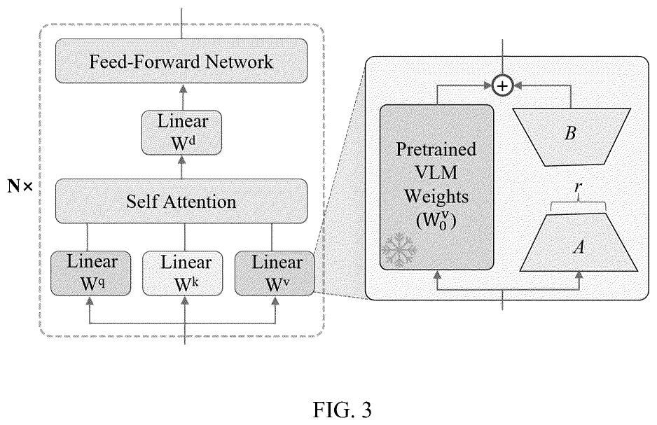

LoRA can be applied to different components of Transformer. Specifically, LoRA is primarily implemented on the query and key projection matrices within the multi-head attention layers of Transformers, as illustrated in FIG. 3. Specifically, during LoRA-based fine-tuning, the pre-trained VLM weight matrix

$${W}_{0}^{v}$$

in Transformer architecture is adjusted to

$${W}^{v} = {W}_{0}^{v} + Δ W ,$$

where ΔW represents a low-rank matrix derived from the product of two matrices A and B (with rank r). This allows for minimal alteration of

$${W}_{0}^{v}$$

while supporting effective fine-tuning. The optimization objective throughout the fine-tuning process is to minimize the loss function L(θ, A, B) for the target task:

$$L ( θ , A , B ) = {\sum }_{i} ℓ ( f ( {x}_{j} ; {W}_{0} + A B ) , {y}_{i} ) , \qquad ( 1 )$$

where θ signifies parameters other than A and B. W₀ denote all pre-trained VLM weight. xᵢ and yᵢ denote input samples i and their labels, respectively. By integrating low-rank matrices into the pre-trained VLM and training only these few parameters, this approach reduces computational demands while preserving the original VLM's knowledge. Thus, through the LoRA-based fine-tuning technique, the model can achieve improved accuracy in understanding construction site hazards while maintaining robust visual and linguistic capabilities.

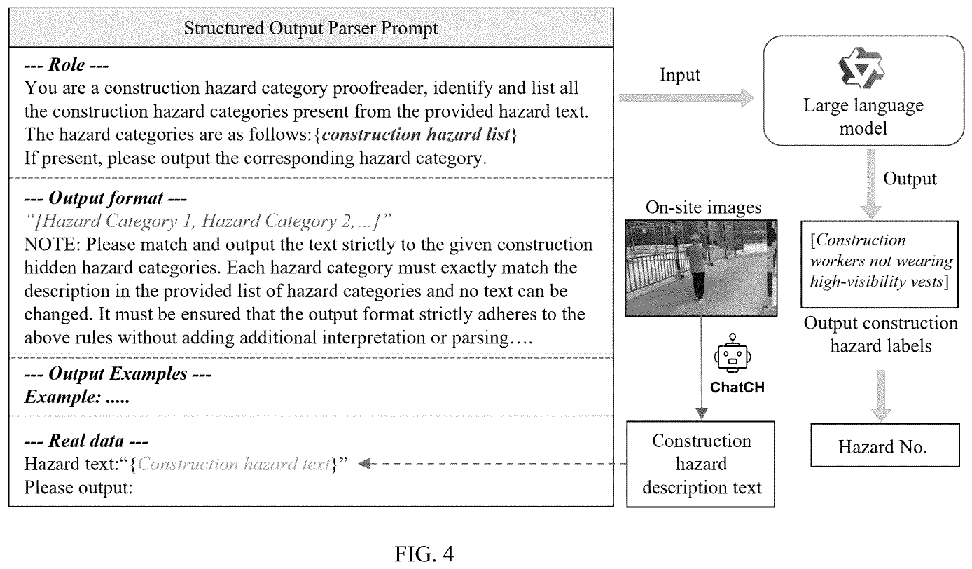

To address the issue of inaccurate model evaluation due to VLMs not strictly outputting text content in a given format, a structured output parser is provided to tackle this issue. Specifically, the inventors design a prompt, as shown in FIG. 4, which comprises four main parts: role and task definitions, output format, sample output, and real data. This structured prompt design enhances the consistency and reliability of the model output, making subsequent automated processing and evaluation more efficient and accurate. Therefore, by introducing structured output parser, the inventors ensure that the content generated by the VLM conforms to the expected format and accurately reflects the VLM's performance in identifying construction hazards.

To enhance the efficiency of construction safety management, this section proposes an end-to-end methodology for automatically generating construction hazard reports through the identifier ChatCH and prompt engineering techniques. The system is deployed on a server architecture (FIG. 2B), with its operational workflow formalized in Algorithm 1. The input parameter batch size b aligns with the maximum token length constraints of the LLM. To optimize processing efficiency and reduce computational overhead, key frames are sampled at fixed temporal intervals Δt.

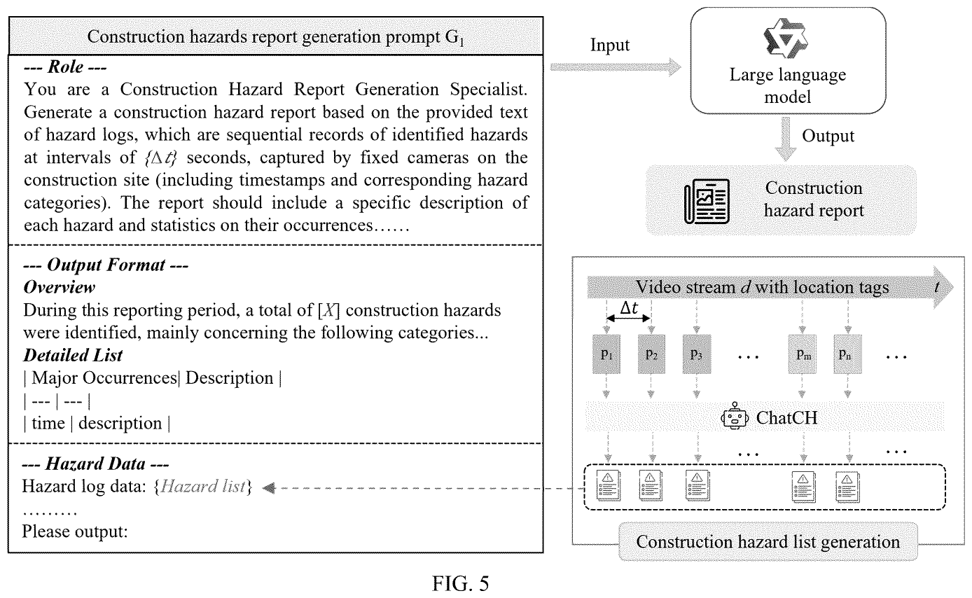

A specialized LLM prompt G₁, specifically designed for construction hazard documentation, is developed to transform sequential construction images into structured hazard reports. As shown in FIG. 5, G₁ comprises three components: (1) role definitions to establish task context and output format requirements for the LLM, (2) exemplar output templates containing overview summaries and detailed itemized lists to standardize reporting, and (3) hazard lists with positional tags extracted from video streams via ChatCH.

The complete data processing workflow operates as follows. Line 1 of Algorithm 1 initializes empty sets for report R and live hazard records LH, as well as the timestamp of the last identification frame TL. Line 2 continuously reads the incoming video stream. Line 3 determines if the current frame is a key frame required for hazard identification. Lines 4 to 6 employ ChatCH to identify hazards within images by extracting visual features and semantic information pertinent to the construction environment. Each image sequence is analyzed to ascertain whether a hazard exists that requires recording, then the identified hazard r and associated (or matched) data are added to the set LH while updating TL. Lines 7 to 10 describe the process when the count of hazards in set LH surpasses b; the specialized LLM prompt G₁ is applied to generate a report for that batch of hazards, adding result r to set R, and subsequently clearing LH. Ultimately, the final construction hazard report CHR is generated using the collection R with the LLM and designed prompt G₂. Specifically, similar to the architecture of G₁, G₂ aggregates all batched hazard reports in the set R into a comprehensive output, which includes hazard categories and descriptions corresponding to their respective locations.

This framework reduces manual intervention requirements while enabling real-time hazard monitoring and alerting. By automating hazard identification and documentation, the system provides timely and precise safety insights, thereby improving the intelligence and effectiveness of construction site safety management. These advancements strengthen behavior-based safety (BBS) management practices, supporting accident prevention, worker protection, and project continuity.

Algorithm 1: End-to-end construction hazard report generation

Input: Video stream d with location tags; batch
size b; time intervalΔt; report generation prompt
G.
Output: Construction hazard report CHR.

| 1 | Initialize empty sets for report R and live | | | |
|---|---|---|---|---|
| | hazard records LH; Initialize last | | | |
| | identification frame time TL. | | | |
| 2 | while receiving frames f from d do | | | |
| 3 | \| | if current time CT − TL >= Δt then | | |
| 4 | \| | \| | hazard record h ← ChatCH (f) | |
| 5 | \| | \| | add h to LH | |
| 6 | \| | \| | TL ← CT | |
| 7 | \| | \| | if length (LH) >= b then | |
| 8 | \| | \| | \| | r ← LLM (LH, G₁) |
| 9 | \| | \| | \| | add r to R |
| 10 | \| | \| | \| | empty LH |

| | | | |
|---|---|---|---|
| 11 | \| | \| | end |

| | | |
|---|---|---|
| 12 | \| | end |

| | |
|---|---|
| 13 | end |
| 14 | CHR ← LLM (R, G₂) |
| 15 | return CHR |

### CHD Dataset

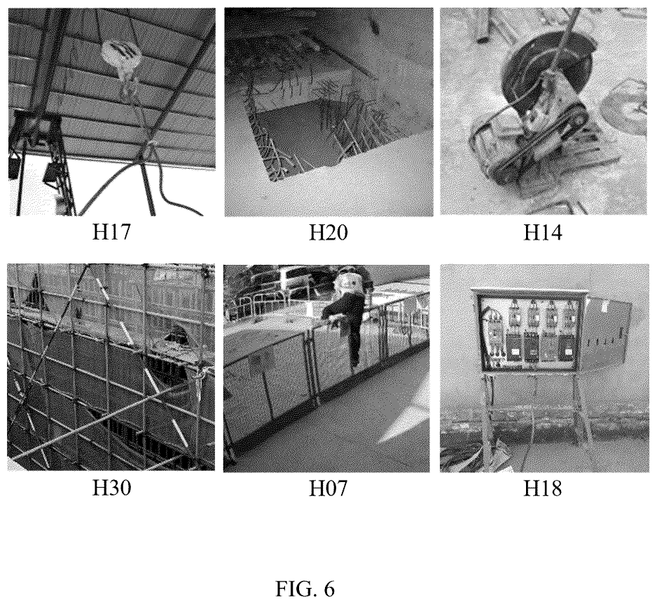

As presented in Table 2, the present invention encompasses 32 specific and common construction hazards. Subsequently, corresponding construction site images for these hazard categories were collected. These images primarily originate from historical inspection records captured by safety managers, each annotated with a detailed description of the associated hazard. Due to the limited volume of historical hazard images, the CHD dataset is augmented using publicly accessible datasets (e.g., CPPED [9] and Scene Graph Dataset of Construction Sites [53]) and internet resources. A filtering (screening) process was applied to all images, involving verifying their relevance to construction site scenarios, removing low-quality or blurry images, and employing generative AI techniques to remove text from the images. Image annotation is conducted using AliCloud's iTag tool, incorporating rigorous quality assurance steps such as cross-auditing among annotators and final review by construction managers to ensure dataset integrity. The resulting CHD dataset comprises 1,308 images of construction hazards. The CHD dataset contains example images along with their corresponding construction hazard labels, as shown in FIG. 6.

TABLE 2
32 categories of construction hazards

| Type | No. | Description of construction hazard categories |
|---|---|---|
| T1 PPE | H01 | Construction workers not wearing safety helmets |
| | H02 | Safety helmets worn but chin straps not secured |
| | H03 | Construction workers not wearing high-visibility vests |
| | H04 | Construction workers not wearing protective footwear (e.g., |
| | | wearing flip-flops) |
| | H05 | Protective gloves not used during material handling and other |
| | | construction activities |
| | H06 | Workers performing elevated work without harnesses or |
| | | improperly attached lanyards |
| T2 Worker | H07 | Climbing over safety barriers or guardrails by construction |
| Behavior | | personnel |
| | H08 | Improper use of power strips |
| | H09 | Transportation or lifting of construction personnel by machinery |
| | H10 | Smoking by construction workers |
| | H11 | Entry into excavator operational zones by personnel |
| | H12 | Resting in non-designated areas within the construction site (e.g., |
| | | sitting or lying down) |
| | H13 | Unauthorized use of open flames |
| T3 Tools and | H14 | Rotating parts of machinery not equipped with guards |
| Equipment | H15 | Crane operations conducted without establishing safety exclusion |
| | | zones around the crane |
| | H16 | Cylinders lacking proper protective measures |
| | H17 | Hooks missing safety latches |
| | H18 | Electrical distribution boards left with doors unsecured |
| T4 | H19 | Edge protection guardrails absent or defective |
| Environment | H20 | Openings and shafts inadequately enclosed |
| | H21 | Guardrails not installed at open sides of stairways |
| | H22 | Electrical distribution boards in direct contact with the ground |
| | H23 | Electrical wiring not elevated (laid directly on the ground) or |
| | | haphazardly arranged |
| | H24 | Electrical wires submerged in water |
| | H25 | Presence of standing water on the construction site. |
| | H26 | Failure to clear domestic or construction waste from the site |
| | H27 | Construction materials stored in a disorderly manner |
| | H28 | Insufficient stability or inadequate safety measures for temporary |
| | | passageways |
| | H29 | Miscellaneous items improperly stored on scaffolding |
| | H30 | Damaged safety nets on exterior scaffolding facades |
| | H31 | Broken dust control netting on the construction site |
| | H32 | Gaps present in the perimeter fencing of the construction site |

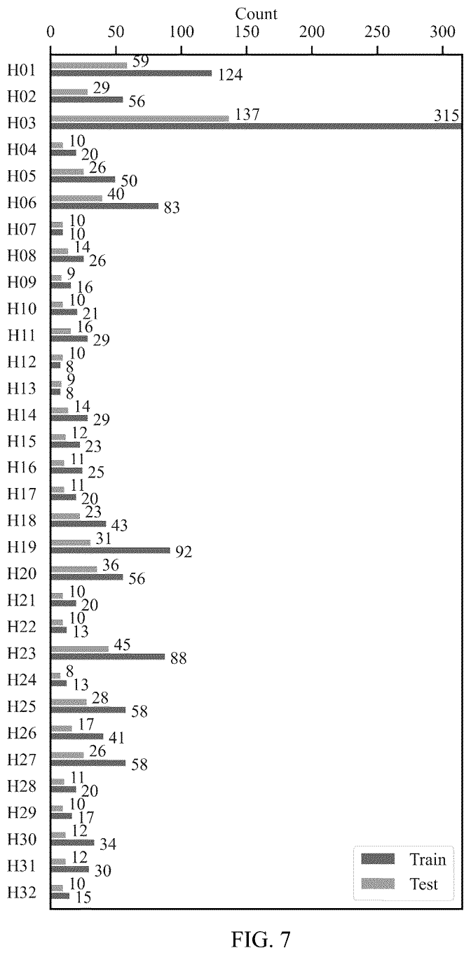

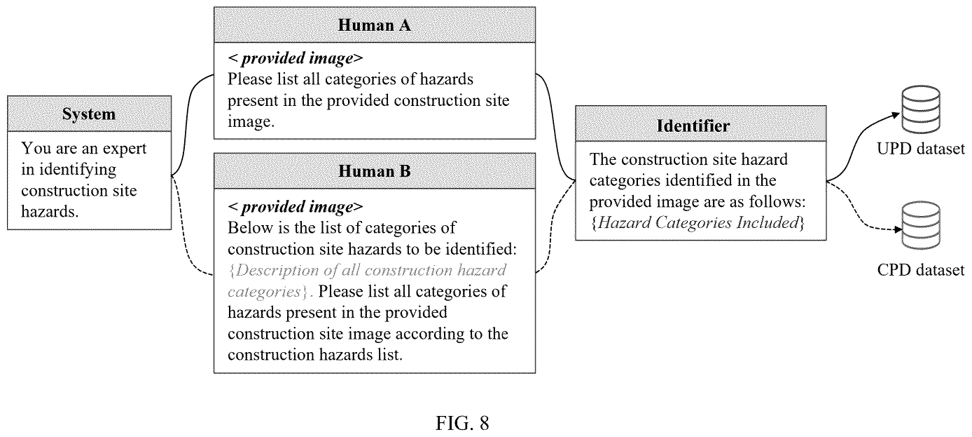

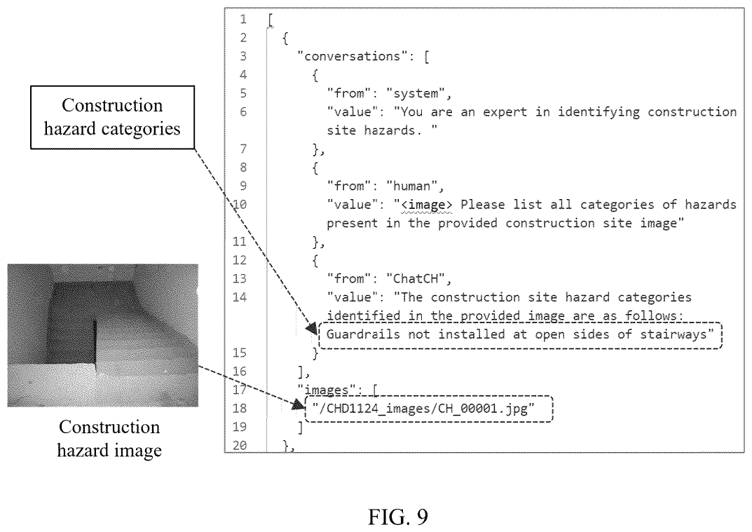

In dividing the dataset into training and test sets, the inventors utilize a stratified sampling method to achieve an approximate 7:3 ratio. However, some hazard categories have very few instances. To ensure the effectiveness of the evaluation, the inventors adjust the proportion of sample data division in this part and prioritize ensuring sufficient instances in the test set for reliable performance evaluation. The final distribution of labels across the training and test sets is illustrated in FIG. 7. Considering the significance of prompts for fine-tuning VLMs, an appropriate prompt design for VLM fine-tuning can markedly enhance model performance on specific tasks [64]. Therefore, two types of prompts are designed for subsequent experimental comparisons: one encompassing all category descriptions and another excluding these specific descriptions, as illustrated in FIG. 8. The corresponding hazard descriptions are derived from the “Description of construction hazard categories” column in Table 2. Specifically, the dataset constructed with “Human A” is the Uncategorized Prompt Dataset (UPD), while the one developed using “Human B” is the Categorized Prompt Dataset (CPD). The key difference between these two datasets lies in whether all hazard label descriptions are provided in the “Human” component. The structure of the UPD's json file is illustrated in FIG. 9.

### Experimentation and Evaluation

Multiple experiments are designed to evaluate the provided method. To validate the provided method for end-to-end construction hazard report generation, a specific construction project is selected, with real construction site videos utilized for testing

Based on the constructed datasets, CPD and UPD, the present invention employs the LoRA technique to fine-tune the pre-trained VLMs. Specifically, Qwen2-VL (https://huggingface.co/Qwen) with parameter sizes of 2 billion and 7 billion and LLaVA-1.5 (https://huggingface.co/llava-hf/llava-1.5-7b-hf) with 7 billion are selected for experimentation. Using training sets from the CPD and UPD datasets, these models are fine-tuned and validated using their respective test sets. To track model performance accurately and avoid underfitting or overfitting, the approach involves saving and evaluating the model every 3 epochs. Notably, the same structured output parser prompt shown in FIG. 4 is used for label alignment during the validation of VLM effects.

For an effective comparison, the traditional VLMs, CLIP and Blip, serve as the baseline models. Specifically, CLIP-based methods utilize the VIT-B/32 Transformer architecture as the image encoder and employ a masked self-attention Transformer as the text encoder (https://huggingface.co/openai/clip-vit-base-patch32). Meanwhile, Blip-based methods adopt the blip-image-captioning-large model (https://huggingface.co/Salesforce/blip-image-captioning-large). According to previous research by Chen et al. [54] and Tsai et al. [18], this process involves fine-tuning the CLIP and Blip model with images and labels. During validation, predictions occur by comparing similarity scores between test set images and construction hazard labels. A label is considered a prediction if its similarity score exceeds a preset threshold d.

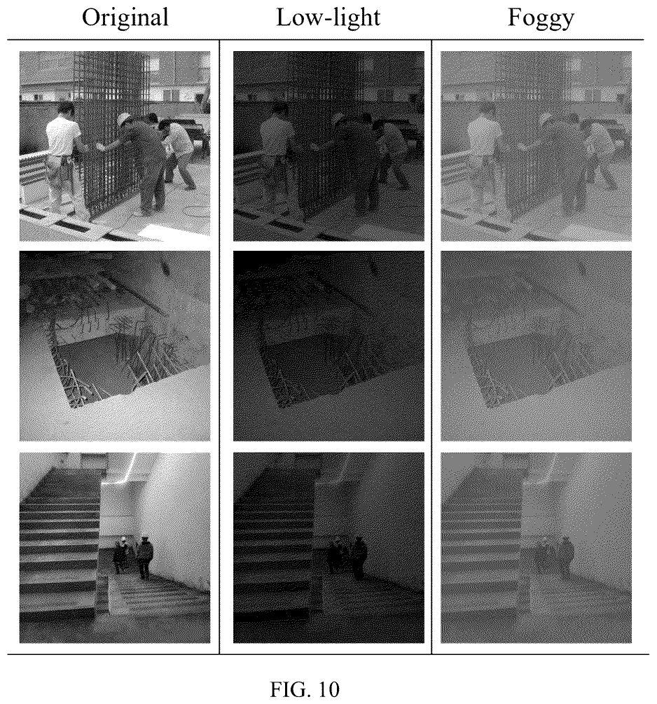

Few-Shot Learning is a machine learning paradigm that focuses on developing algorithms capable of quickly adapting to new tasks or categories with only a small number of samples [65]. This capability is particularly important in construction scenarios where data scarcity is common. To evaluate the performance of ChatCH under limited data conditions, the experimental design uses 2, 5, 10, and 20 randomly selected samples from the training portion of the CPD dataset for each category of construction hazards. The corresponding full test sets are then used for evaluation. Additionally, to assess model robustness, foggy and low-light conditions simulate by processing images from the CHD's test set (see FIG. 10) using a Python script developed for this purpose (accessible at https://github.com/QHCV/lowlight-foggy), following methods described by Chen et al. [9] and Ferdous and Ahsan [66]. Finally, the provided method for automatic construction hazard report generation validates in a real-world construction project, utilizing video footage from the research by Chen et al. [9].

### Evaluation Metrics and Implementation Details

To evaluate the model's performance, the inventors apply several widely accepted metrics. Precision, the proportion of correctly identified positive samples among those predicted as positive; recall, the proportion of actual positives correctly identified; and the F1 score, which is the harmonic mean of precision and recall, are calculated using the formulas:

$$Precision = \frac{TP}{TPP + FP} , \qquad ( 2 )$$

$$Recall = \frac{TP}{TP + FN} , \qquad ( 3 )$$

$$F 1 score = 2 \cdot \frac{P r e c ision \cdot Recall}{P r e c i s i o n + R e c a l l} , \qquad ( 4 )$$

where, TP stands for true positive, TN for true negative, FP for false positive, and FN for false negative. Additionally, to emphasize the significance of recall and minimize missed detections, especially given the potential severity of construction site accidents, the inventors calculate the F2 score (β=2):

$$F 2 score = ( 1 + {β}^{2} ) \cdot \frac{P r e c ision \cdot Recall}{( {β}^{2} \cdot Precision ) + R e c a l l} . \qquad ( 5 )$$

The F2 score assigns greater weight to recall relative to precision, ensuring that potential construction hazards are detected as thoroughly as possible. Cohen's Kappa [67] measures the agreement between observed and expected outcomes beyond chance, and is calculated as:

$$κ = \frac{{p}_{o} - {p}_{e}}{1 - {p}_{e}} , \qquad ( 6 )$$

where, pₒ is the observed agreement rate and pe is the expected agreement rate by chance. A Cohen's Kappa close to 1 signifies near-perfect agreement, indicating that the model significantly outperforms random guessing, thereby enhancing confidence in the model's reliability. Conversely, values near or below 0 suggest that the agreement does not exceed or may be worse than what would be expected by chance, highlighting potential limitations of the model.

During the experimental process, the inventors adopted the Llama-Factory [68] an efficient fine-tuning framework. Specific parameter settings included a LoRA rank of 8, a learning rate of 0.00005, and the threshold d set to 0.95. The LLM used is Qwen2.5-14B model, deployed on a local server, with the capability to receive up to 32,768 input tokens. In the application of the automatic construction hazard report generation method, the batch size b is set to 300, and Δt is set to 2 seconds. All experiments are conducted on a server equipped with GPU (32 GB memory) running the Ubuntu 22.04 operating system.

### Construction Hazard Identification Results of Fine-Tuned VLMs

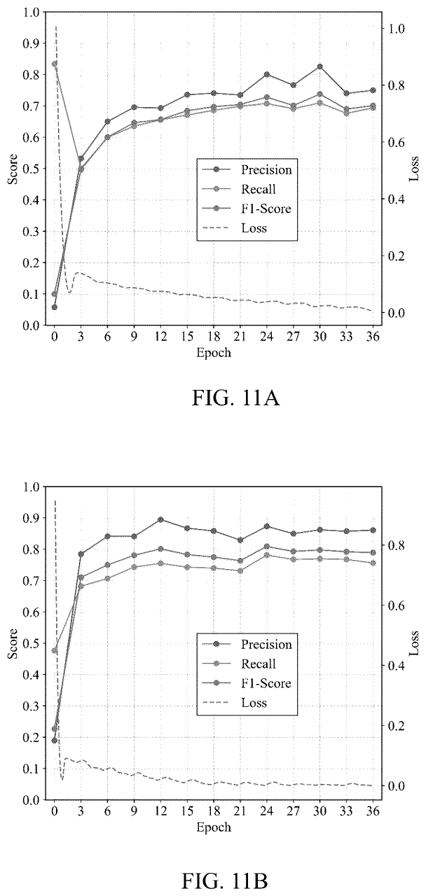

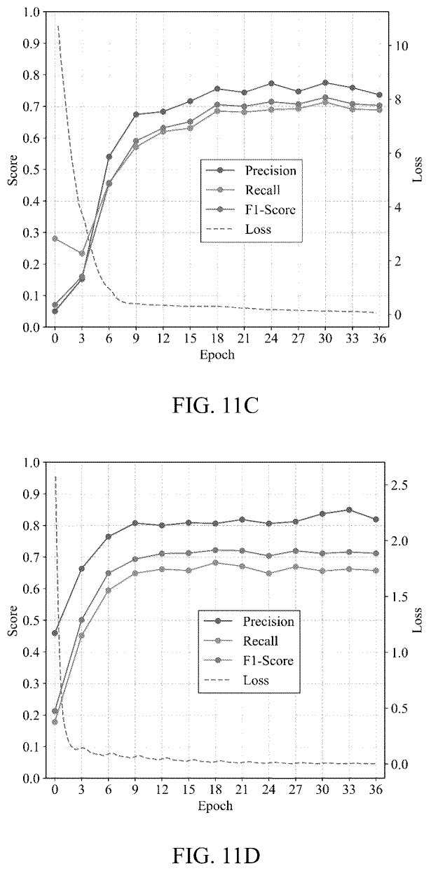

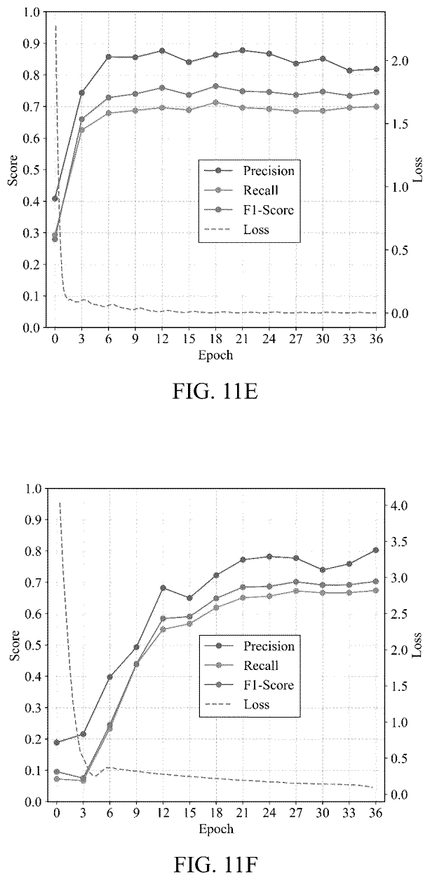

According to the above experimental design, FIG. 11 illustrates the results on the CPD and UPD datasets using pre-trained VLMs with two parameter sizes along with the corresponding loss curves from the training processes. As shown in the figure, the loss curves for all training processes drop sharply by the third epoch before gradually stabilizing in the following epochs. FIG. 11A highlights ChatCH using the Qwen2-VL-2B model's performance on the CPD dataset. Without fine-tuning, the model achieves a high recall near 0.85 but suffers from very low precision at 0.05, leading to an F1-Score of only 0.1. Fine-tuning significantly enhances identification of construction hazards, increasing precision to 0.47 by the third epoch and reaching a peak precision of 0.825 by the 30th epoch. FIG. 11B shows ChatCH using the Qwen2-VL-7B model's performance on the same CPD dataset. Before fine-tuning, this model has an F1-Score of 0.226, marginally better than the Qwen2-VL-2B model in FIG. 11A. After the third epoch, the performance stabilizes and reaches a maximum accuracy of 0.894 by the 12th epoch, marking a 0.705 improvement over the non-fine-tuned state. FIG. 11C presents the results of ChatCH using the LLaVA1.5-7B model on the CPD dataset. The model demonstrates steady performance improvement during training, stabilizing after the 18th epoch with F1-scores consistently above 0.7, though remaining lower than the results in FIG. 11B. FIG. 11D shows the results for ChatCH using the Qwen2-VL-2B model on the UPD dataset. The training process stabilizes after the ninth epoch, resulting in an F1-score comparable to FIG. 11A, attributed to lower recall despite higher precision on the CPD dataset. Conversely, FIG. 11E depicts ChatCH using the Qwen2-VL-7B model on the UPD dataset, with stabilization occurring after the third epoch. Compared to FIG. 11B, the model performs better without fine-tuning; however, the precision, recall, and F1-Score are lower than those in FIG. 11B overall after fine-tuning. FIG. 11F shows the results of ChatCH using the LLaVA1.5-7B model on the UPD dataset, exhibiting an overall upward trend with occasional fluctuations. The F1-score approaches 0.7, while the recall rate remains slightly lower than that in FIG. 11C. This indicates that the CPD dataset is more conducive to enhancing the effectiveness of fine-tuning, particularly in boosting recall. In conclusion, larger pre-trained model parameters and the inclusion of descriptive construction hazard details in the fine-tuned prompt contribute to improved performance of the construction hazard identification.

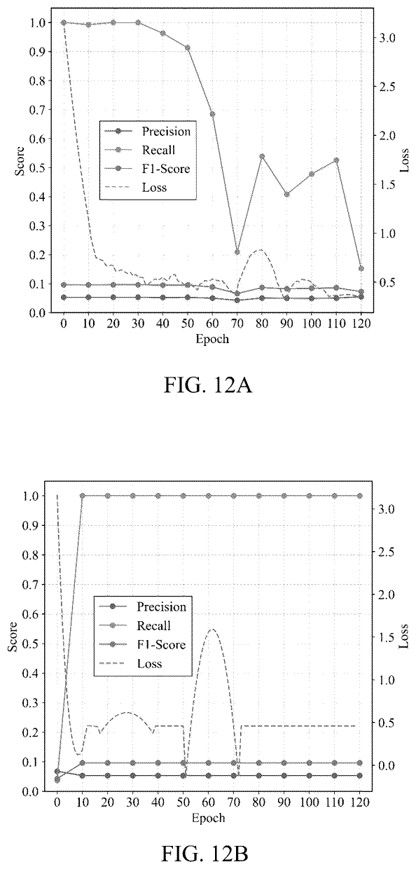

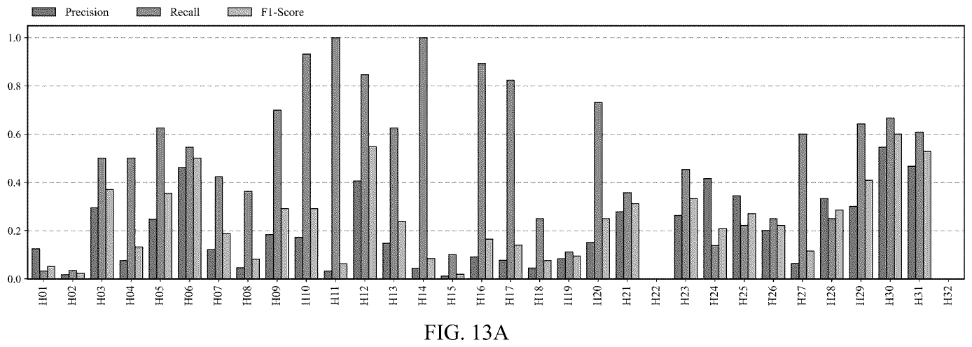

The loss curve depicted in FIG. 12 indicates the trend of the loss value over time during the pre-trained CLIP and Blip model's fine-tuning process. Initially, the loss is relatively high but progressively decreases with time until it stabilizes. For the construction hazard identification task, as show in FIG. 12A the pre-trained CLIP model exhibits a recall close to 1, indicating near-perfect detection of positive samples. However, the model's precision remains consistently around 0.05 and does not significantly improve with fine-tuning. Additionally, as fine-tuning progresses, recall tends to decrease, suggesting a reduced ability of the model to accurately identify positive samples. As show in FIG. 12B, the Blip model exhibits similarly poor performance, with recall jumping from 0.037 (pre-fine-tuning) to 1 (post-fine-tuning), while precision and F1-score remain unchanged at 0.053 and 0.096, respectively. Fine-tuning fails to yield significant improvements in precision or F1 scores, underscoring the model's persistent challenges in distinguishing construction hazards. In summary, despite undergoing the fine-tuning process, the CLIP and Blip model struggles to adequately understand and differentiate features related to construction hazards, which limits its application for this specific task. The capabilities of the traditional pre-trained CLIP and Blip model insufficient for effectively addressing the complexities of construction hazard identification.

Table 3 provides F2 scores, Cohen's Kappa values, and frames-per-second (FPS) data for model identification on the test set. It compares two main models: CLIP-based and Qwen2-VL (2B and 7B), each evaluated with and without fine-tuning. For the CLIP-based model, fine-tuning does not lead to performance improvements in construction hazard identification. Both its F2 score and Cohen's Kappa decrease, indicating that fine-tuning does not benefit this model for construction hazard identification task. In contrast, the Qwen2-VL model shows significant improvements after fine-tuning. On the CPD dataset, the Qwen2-VL-2B model starts with an F2 score of 22.46% and a Cohen's Kappa of −0.03%. The Qwen2-VL-7B model begins with an F2 score of 36.5% and a Cohen's Kappa of 11.8%. After fine-tuning, the Qwen2-VL-7B model achieves an F2 score of 77.89% and a Cohen's Kappa of 75.13%, marking substantial improvements of 41.39% and 63.33%, respectively. These results highlight the effectiveness of fine-tuning in enhancing the Qwen2-VL model's performance, particularly in balancing precision and recall. The overall performance of the fine-tuned Qwen2-VL model on the UPD dataset is slightly lower than on the CPD dataset, suggesting that including specific construction hazard category descriptions in the fine-tuning prompts aids in improving identification performance.

TABLE 3
F2 score and Cohen's Kappa results for different pre-trained VLMs.

| Dataset | Pre-trained VLMs | F2 score | Cohen's Kappa | FPS |
|---|---|---|---|---|
| CHD | CLIP-based | 21.88% | 0.00% | 47.62 |
| | CLIP-based (Fine-tuned) | 21.45% (−0.43%) | −0.13% (−0.13%) | 52.63 |
| CPD | Qwen2-VL-2B | 22.46% | −0.03% | 0.280 |
| | 2B (Fine-tuned) | 72.99% (+50.53%) | 61.41% (+61.44%) | 0.968 |
| | 7B | 36.50% | 11.80% | 0.458 |
| | 7B (Fine-tuned) | 77.89% (+41.39%) | 75.13% (+63.33%) | 1.269 |
| UPD | Qwen2-VL-2B | 20.27% | 13.82% | 0.488 |
| | Qwen2-VL-2B (Fine-tuned) | 70.34% (+50.07%) | 64.64% (+50.82%) | 1.021 |
| | Qwen2-VL-7B | 31.09% | 17.90% | 0.358 |
| | Qwen2-VL-7B (Fine-tuned) | 72.60% (+41.51%) | 65.40% (+47.50%) | 0.949 |

Regarding identification efficiency, models fine-tuned using the LoRA technique generally exhibit faster identification speeds. For example, under identical hardware conditions, the FPS for the Qwen2-VL-2B model increases from 0.280 without fine-tuning to 0.968 after fine-tuning. Fine-tuning with the CPD dataset also leads to higher speeds compared to using the UPD dataset; the Qwen2-VL-7B model reaches an FPS of 1.269 on the CPD dataset versus 0.949 on the UPD dataset. While the CLIP-based model boasts a high FPS of 52.63, its low accuracy in construction hazard identification means this speed advantage does not constitute an effective benefit. Therefore, adding specific construction hazard category descriptions during the fine-tuning process enhances both identification accuracy and speed.

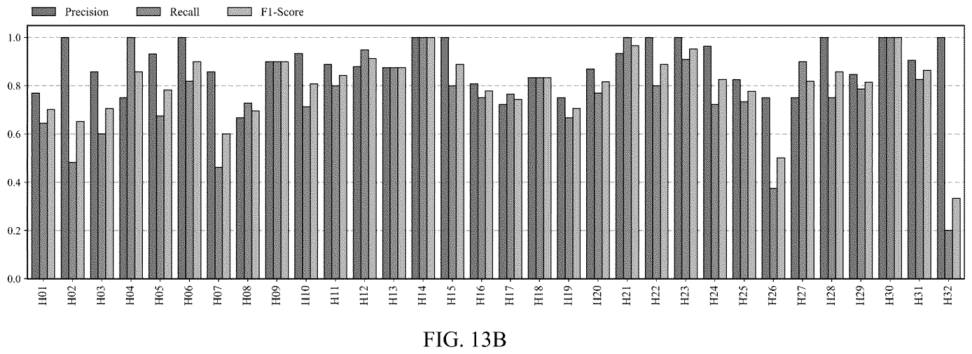

FIG. 13 illustrates the performance of identifying each category of construction hazards before and after fine-tuning with the Qwen2-VL-7B model. In FIG. 13A, which shows the model's performance without fine-tuning, two categories of hazards, H22 and H32, are not identified at all. Additionally, three categories—H01, H02, and H15—exhibit very low identification precision and recall, nearly approaching zero. While a few categories achieve high recall, such as H11 and H14 with recalls close to 1, the precision across all categories remains below 0.6. After fine-tuning, as depicted in FIG. 13B, the model's performance on each category of construction hazards markedly improves. Most categories have identification precision and recall above 0.8. Notably, categories that are previously unidentified, like H22, are now successfully identified. For instance, category H22 achieves a precision of 1.0 and a recall of 0.8 post fine-tuning, demonstrating a significant enhancement in the model's ability to identify this category of construction hazard. These improvements highlight the effectiveness of fine-tuning in enhancing the ChatCH's capability to accurately identify various construction hazards.

### Few-Shot Learning Results of Fine-Tuned VLMs

According to the experimental design, Table 4 presents the performance of the pre-trained Qwen2-VL-7B model fine-tuned using varying numbers of samples per construction hazard category. The results shown are the average of the best three epoch evaluation outcomes. Overall, as the number of training samples per category increases, the model's performance exhibits an upward trend across several evaluation metrics. When two samples per category are used for fine-tuning compared to no fine-tuning, there is a significant improvement in construction hazard identification: precision increases by 54.99%, and recall by 14.81%. As the amount of sample data per category for fine-tuning increases further, the model's performance continues to improve, albeit at a slower rate. For instance, increasing the number of samples from 10 to 20 per category leads to a slight decrease in recall by 1.21%, yet precision reaches 80.63%, marking an improvement of 4.88%. This indicates that even a small number of samples can significantly enhance the model's effectiveness.

TABLE 4
Performance under sample-limited fine-
tuning using the Qwen2-VL-7B model.

| Number of each | | | F1- | F2- | Cohen's |
|---|---|---|---|---|---|
| category | Precision | Recall | Score | Score | Kappa |
| 0 | 18.89% | 47.58% | 22.66% | 36.50% | 11.80% |
| 2 | 73.88% | 62.39% | 65.46% | 64.36% | 55.81% |
| 5 | 74.27% | 76.40% | 74.13% | 75.96% | 63.40% |
| 10 | 75.75% | 77.40% | 74.51% | 77.06% | 65.52% |
| 20 | 80.63% | 76.19% | 76.75% | 77.04% | 68.17% |

### Fine-Tuned VLM Robustness Test Results

To evaluate the robustness of the fine-tuned VLM in construction hazard identification task, the test set images in the CPD dataset are manipulated to simulate low-light and foggy scenarios. Table 5 shows the average values from six repeated experiments under these scenarios. The variance of F1-scores across all six trials remained below 0.000008, demonstrating exceptional stability and reliability in model performance under varying environmental conditions. The results indicate that the performance of ChatCH using pre-trained Qwen2-VL-2B model decreases to varying degrees in both low-light and foggy scenes. Specifically, in low-light conditions, precision drops by 2.53%, and recall decreases by 3.48%.

In foggy conditions, precision decreases by 6.29%, and recall decreases by 3.24%. Conversely, when ChatCH using pre-trained the Qwen2-VL-7B model, the decrease in performance is minimal under both conditions, and some metrics even improve. In low-light conditions, precision only decreases by 1.43%, while recall slightly increases by 0.01%. In foggy conditions, precision decreases by just 0.64%, whereas recall improves by 0.14%. These findings demonstrate that the fine-tuned pre-trained VLM for construction hazard identification exhibits strong robustness, particularly when a pre-trained model with a higher size of parameters is utilized.

TABLE 5
Performance in low-light and foggy scenes using
pre-trained Qwen2 VL 2B and 7B models.

| Model | Test data | Precision | Recall | F1-Score | F2-Score | Cohen's Kappa |
|---|---|---|---|---|---|---|
| Qwen2- | Raw | 82.47% | 70.87% | 73.72% | 72.92% | 61.58% |
| VL-2B | Low-light | 79.93% | 67.39% | 70.03% | 69.57% | 60.36% |
| (CPD) | | (−2.53%) | (−3.48%) | (−3.69%) | (−3.35%) | (−1.22%) |
| | Foggy | 76.17% | 67.62% | 69.84% | 69.18% | 60.09% |
| | | (−6.29%) | (−3.24%) | (−3.88%) | (−3.74%) | (−1.49%) |
| Qwen2- | Raw | 89.45% | 75.44% | 80.09% | 77.88% | 75.05% |
| VL-7B | Low-light | 88.01% | 75.45% | 79.94% | 77.66% | 72.10% |
| (CPD) | | (−1.43%) | (+0.01%) | (−0.15%) | (−0.22%) | (−2.96%) |
| | Foggy | 88.81% | 75.58% | 79.92% | 77.90% | 75.29% |
| | | (−0.64%) | (+0.14%) | (−0.17%) | (+0.02%) | (+0.23%) |

### End-to-End Construction Hazard Report Generation

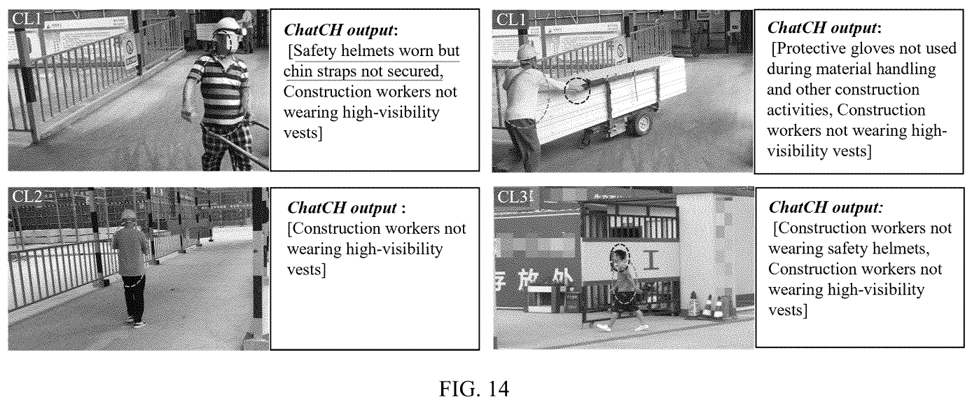

To verify the effectiveness of the automatic construction hazard report generation method provided by the present invention, the inventors refer to Chen et al. [9] and select videos from three distinct areas of an actual construction site: Building material hoist doorway (CL1), Employee access (CL2), and Material entrance and exit (CL3). The videos are chosen from periods when hazards occur more frequently, aiding in assessing the ChatCH's effectiveness. In the experiments, the ChatCH model (based on pre-trained Qwen2-VL-7B fine-tuned on the CPD dataset) along with specifically designed prompts for LLM are used to execute Algorithm 1. FIG. 14 shows examples of construction hazard identification results from ChatCH output (after structured output parser) at different construction locations. Even very detailed hazards, such as the lack of gloves during material handling, can be identified.

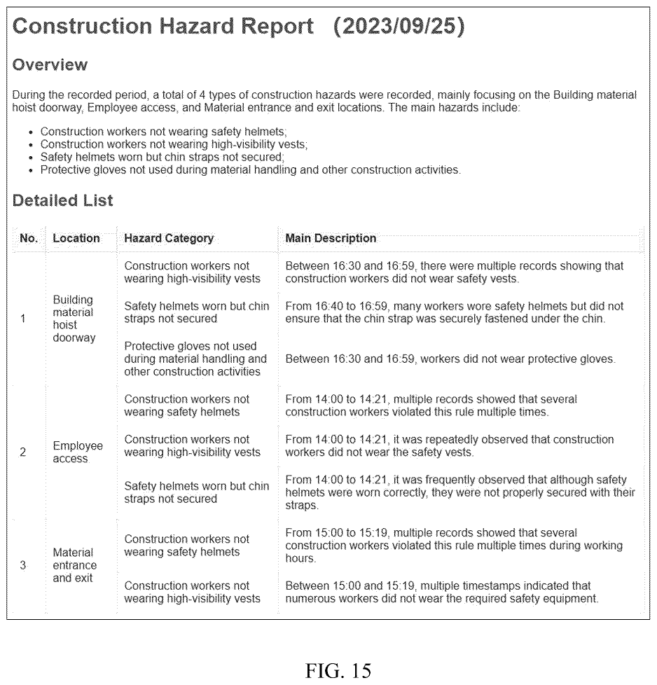

The final generated construction hazard reports are shown in FIG. 15. The results indicate that the LLM can produce the required content of a construction hazard report according to pre-designed prompts, providing clear and concise information for safety managers. The identified hazards are categorized into four types, with three, three, and two hazards identified at CL1, CL2, and CL3, respectively. This categorization aligns with the actual hazard types observed in the videos, with corresponding hazard records derived from the study by Chen et al. [9]. Regarding identification efficiency, the average time per image for CL1, CL2, and CL3 is 0.907, 0.935, and 0.846 seconds, meaning each image is processed in less than one second, while video frames are extracted at intervals of two seconds. Thus, our method not only achieves rapid video data processing but also maintains accuracy and real-time hazard identification. Such efficiency and accuracy are crucial for construction site safety monitoring, allowing timely detection and reporting of potential hazards so appropriate preventive actions can be taken promptly to decrease accident rates. Moreover, compared to traditional manual inspection and report generation, this automated approach significantly enhances identification efficiency and reduces labor costs.

The functional units and modules in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

While the present disclosure has been described and illustrated with reference to specific embodiments thereof, these descriptions and illustrations are not limiting. The illustrations may not necessarily be drawn to scale. There may be distinctions between the illustrations in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

### REFERENCES

[1] B. Yuan, S. Xu, M. Niu, K. Guo. Will improved safety attitudes necessarily curb unsafe behavior? Hybrid method based on NCA and SEM. Journal of Environmental and Public Health. 2022 (1): 9271690, 2022. https://doi.org/10.1155/2022/9271690.
[2] Y. Han, Y. Diao, Z. Yin, R. Jin, J. Kangwa, O. J. Ebohon. Immersive technology-driven investigations on influence factors of cognitive load incurred in construction site hazard recognition, analysis and decision making. Advanced Engineering Informatics. 48 101298, 2021. https://doi.org/10.1016/j.aei.2021.101298.
[3] Q. Chen, D. Long, C. Yang, H. Xu. Knowledge Graph Improved Dynamic Risk Analysis Method for Behavior-Based Safety Management on a Construction Site. Journal of Management in Engineering. 39 (4): 04023023, 2023. https://doi.org/10.1061/JMENEA.MEENG-5306.
[4] X. Zhang, D. Tian, Q. Ren, M. Li, Y. Shen, S. Han. A hybrid deep semantic mining method considering fuzzy expressions for the automatic recognition of construction safety hazard information. Advanced Engineering Informatics. 61 102507, 2024. https://doi.org/10.1016/j.aei.2024.102507.
[5] Q. Xiang, G. Ye, Y. Liu, Y. Miang Goh, D. Wang, T. He. Cognitive mechanism of construction workers' unsafe behavior: A systematic review. Safety Science. 159 106037, 2023. https://doi.org/10.1016/j.ssci.2022.106037.
[6] Z. Hu, W. T. Chan, H. Hu, F. Xu. Cognitive Factors Underlying Unsafe Behaviors of Construction Workers as a Tool in Safety Management: A Review. Journal of Construction Engineering and Management. 149 (3): 03123001, 2023 https://doi.org/10.1061/JCEMD4.COENG-11820.
[7] Y. Ouyang, X. Luo. Differences between inexperienced and experienced safety supervisors in identifying construction hazards: Seeking insights for training the inexperienced. Advanced Engineering Informatics. 52 101602, 2022. https://doi.org/10.1016/j.aei.2022.101602.
[8] Y. Wang, B. Xiao, A. Bouferguene, M. Al-Hussein. Proactive safety hazard identification using visual-text semantic similarity for construction safety management. Automation in Construction. 166 105602, 2024. https://doi.org/10.1016/j.autcon.2024.105602.
[9] Q. Chen, D. Long, S. Wang, Q. Chen, B. Yuan. Real-Time Detection of Personal Protective Equipment Violations for Construction Workers Using Semisupervised Learning and Video Clips. Journal of Construction Engineering and Management. 151 (3): 04024213, 2025. https://doi.org/10.1061/JCEMD4.COENG-15310.
[10] B. Xiao, X. Yin, S.-C. Kang. Vision-based method of automatically detecting construction video highlights by integrating machine tracking and CNN feature extraction. Automation in Construction. 129 103817, 2021. https://doi.org/10.1016/j.autcon.2021.103817.
[11] S. Chen, K. Demachi, F. Dong. Graph-based linguistic and visual information integration for on-site occupational hazards identification. Automation in Construction. 137 104191, 2022. https://doi.org/10.1016/j.autcon.2022.104191.
[12] I. Jeelani, K. Asadi, H. Ramshankar, K. Han, A. Albert. Real-time vision-based worker localization & hazard detection for construction. Automation in Construction. 121 103448, 2021. https://doi.org/10.1016/j.autcon.2020.103448.
[13] Y. Wang, H. Luo, W. Fang. An integrated approach for automatic safety inspection in construction: Domain knowledge with multimodal large language model. Advanced Engineering Informatics. 65 103246, 2025. https://doi.org/10.1016/j.aei.2025.103246.
[14] B. Xiao, Y. Zhang, Y. Chen, X. Yin. A semi-supervised learning detection method for vision-based monitoring of construction sites by integrating teacher-student networks and data augmentation. Advanced Engineering Informatics. 50 101372, 2021. https://doi.org/10.1016/j.aei.2021.101372.
[15] B. Chen, Z. Xu, S. Kirmani, B. Ichter, D. Sadigh, L. Guibas, F. Xia. Spatialvlm: Endowing vision-language models with spatial reasoning capabilities. Proceedings of the IEEE/CVF Conference on Computer Vision and Pattern Recognition, 2024, pp. 14455-14465. https://doi.org/10.48550/arXiv.2401.12168.
[16] A. Radford, J. W. Kim, C. Hallacy, A. Ramesh, G. Goh, S. Agarwal, G. Sastry, A. Askell, P. Mishkin, J. Clark. Learning transferable visual models from natural language supervision. International conference on machine learning, PMLR, 2021, pp. 8748-8763. https://proceedings.mlr.press/v139/radford21a.
[17] J. Li, D. Li, C. Xiong, S. Hoi. Blip: Bootstrapping language-image pre-training for unified vision-language understanding and generation. International conference on machine learning, PMLR, 2022, pp. 12888-12900. https://proceedings.mlr.press/v162/li22n.html.
[18] W.-L. Tsai, P.-L. Le, W.-F. Ho, N.-W. Chi, J. J. Lin, S. Tang, S.-H. Hsieh. Construction safety inspection with contrastive language-image pre-training (CLIP) image captioning and attention. Automation in Construction. 169 105863, 2025. https://doi.org/10.1016/j.autcon.2024.105863.
[19] D. Gil, G. Lee. Zero-shot monitoring of construction workers' personal protective equipment based on image captioning. Automation in Construction. 164 105470, 2024. https://doi.org/10.1016/j.autcon.2024.105470.
[20] J. Zhang, J. Huang, S. Jin, S. Lu. Vision-Language Models for Vision Tasks: A Survey. IEEE Transactions on Pattern Analysis and Machine Intelligence. 46 (8): 5625-5644, 2024. https://doi.org/10.1109/TPAMI.2024.3369699.
[21] Y. Liang, P. Vadakkepat, D. K. H. Chua, S. Wang, Z. Li, S. Zhang. Recognizing temporary construction site objects using CLIP-based few-shot learning and multi-modal prototypes. Automation in Construction. 165 105542, 2024. https://doi.org/10.1016/j.autcon.2024.105542.
[22] C. Chen, B. Xiao, Y. Zhang, Z. Zhu. Automatic vision-based calculation of excavator earthmoving productivity using zero-shot learning activity recognition. Automation in Construction. 146 104702, 2023. https://doi.org/10.1016/j.autcon.2022.104702.
[23] G. Yong, M. Liu, S. Lee. Explainable Image Captioning to Identify Ergonomic Problems and Solutions for Construction Workers. Journal of Computing in Civil Engineering. 38 (4): 04024022, 2024. https://doi.org/10.1061/JCCEE5.CPENG-5744.
[24] B. Xiao, Y. Wang, Y. Zhang, C. Chen, A. Darko. Automated daily report generation from construction videos using ChatGPT and computer vision. Automation in Construction. 168 105874, 2024. https://doi.org/10.1016/j.autcon.2024.105874.
[25] Y. Ouali, A. Bulat, A. Xenos, A. Zaganidis, I. M. Metaxas, G. Tzimiropoulos, B. Martinez. Discriminative Fine-tuning of LVLMs. arXiv preprint arXiv: 2412.04378. 2024. https://doi.org/10.48550/arXiv.2412.04378.
[26] A. Hurst, A. Lerer, A. P. Goucher, A. Perelman, A. Ramesh, A. Clark, A. Ostrow, A. Welihinda, A. Hayes, A. Radford. Gpt-40 system card. arXiv preprint arXiv: 2410.21276. 2024. https://doi.org/10.48550/arXiv.2410.21276.
[27] H. Liu, C. Li, Q. Wu, Y. J. Lee. Visual instruction tuning. Advances in neural information processing systems, Vol. 36, 2024. https://proceedings.neurips.cc/paper_files/paper/2023/hash/6dcf277ea32ce3288914faf369fe6 de0-Abstract-Conference.html.
[28] P. Wang, S. Bai, S. Tan, S. Wang, Z. Fan, J. Bai, K. Chen, X. Liu, J. Wang, W. Ge. Qwen2-vl: Enhancing vision-language model's perception of the world at any resolution. arXiv preprint arXiv: 2409.12191. 2024. https://doi.org/10.48550/arXiv.2409.12191.
[29] D. Xiao, M. Dianati, P. Jennings, R. Woodman. HazardVLM: A Video Language Model for Real-Time Hazard Description in Automated Driving Systems. IEEE Transactions on Intelligent Vehicles. 1-13, 2024. https://doi.org/10.1109/TIV.2024.3451350.
[30] Z. Gu, B. Zhu, G. Zhu, Y. Chen, M. Tang, J. Wang. Anomalygpt: Detecting industrial anomalies using large vision-language models. Proceedings of the AAAI Conference on Artificial Intelligence, Vol. 38, 2024, pp. 1932-1940. https://doi.org/10.1609/aaai.v3813.27963.
[31] E. J. Hu, P. Wallis, Z. Allen-Zhu, Y. Li, S. Wang, L. Wang, W. Chen. LoRA: Low-Rank Adaptation of Large Language Models. International Conference on Learning Representations. https://openreview.net/forum?id=nZeVKeeFYf9.
[32] B. H. W. Guo, Y. M. Goh, K. Le Xin Wong. A system dynamics view of a behavior-based safety program in the construction industry. Safety Science. 104 202-215, 2018. https://doi.org/10.1016/j.ssci.2018.01.014.
[33] W. Xu, T.-K. Wang. Dynamic safety prewarning mechanism of human-machine-environment using computer vision. Engineering, Construction and Architectural Management. 27 (8): 1813-1833, 2020. https://doi.org/10.1108/ECAM-12-2019-0732.
[34] J. Al-Bayati Ahmed, R. Eiris, O. Hernandez Guillermo, A. Al-Bayati Miriam. Addressing Social Inequity in Construction Safety Research: Personal Protective Equipment Focus. Journal of Construction Engineering and Management. 149 (12): 04023127, 2023. https://doi.org/10.1061/JCEMD4.COENG-13864.
[35] Z. Kolar, H. Chen, X. Luo. Transfer learning and deep convolutional neural networks for safety guardrail detection in 2D images. Automation in Construction. 89 58-70, 2018. https://doi.org/10.1016/j.autcon.2018.01.003.
[36] W. Fang, P. E. D. Love, H. Luo, L. Ding. Computer vision for behaviour-based safety in construction: A review and future directions. Advanced Engineering Informatics. 43 100980, 2020. https://doi.org/10.1016/j.aei.2019.100980.
[37] Z. Tian, S. Zhou, A. Lee, Y. Shan, B. Detmann. How to identify earth pressures on in-service tunnel linings: Insights from Bayesian inversion to address non-uniqueness. Transportation Geotechnics. 48 101344, 2024. https://doi.org/10.1016/j.trgeo.2024.101344.
[38] Y. Jeon, D. Q. Tran, A. S. Kulinan, T. Kim, M. Park, S. Park. Vision-based motion prediction for construction workers safety in real-time multi-camera system. Advanced Engineering Informatics. 62 102898, 2024. https://doi.org/10.1016/j.aei.2024.102898.
[39] J. Yin, X. Yin, M. Pan, L. Li. Scalable and transparent automated sewer defect detection using weakly supervised object localization. Automation in Construction. 174 106152, 2025. https://doi.org/10.1016/j.autcon.2025.106152.
[40] L. Liu, Z. Guo, Z. Liu, Y. Zhang, R. Cai, X. Hu, R. Yang, G. Wang. Multi-Task Intelligent Monitoring of Construction Safety Based on Computer Vision. Buildings. 14 (8): 2429, 2024. https://doi.org/10.3390/buildings14082429.
[41] A. M. Vukicevic, M. Djapan, V. Isailovic, D. Milasinovic, M. Savkovic, P. Milosevic. Generic compliance of industrial PPE by using deep learning techniques. Safety Science. 148 105646, 2022. https://doi.org/10.1016/j.ssci.2021.105646.
[42] X. Mei, W. Ma, F. Xu, Z. Zhang. Vision-Based Detection of Unsafe Worker Guardrail Climbing Based on Posture and Instance Segmentation Data Fusion. Journal of Construction Engineering and Management. 150 (11): 04024156, 2024. https://doi.org/10.1061/JCEMD4.COENG-14266.
[43] M. Yang, C. Wu, Y. Guo, R. Jiang, F. Zhou, J. Zhang, Z. Yang. Transformer-based deep learning model and video dataset for unsafe action identification in construction projects. Automation in Construction. 146 104703, 2023. https://doi.org/10.1016/j.autcon.2022.104703.
[44] M. Park, A. S. Kulinan, D. Q. Tran, J. Bak, S. Park. Preventing falls from floor openings using quadrilateral detection and construction worker pose-estimation. Automation in Construction. 165 105536, 2024. https://doi.org/10.1016/j.autcon.2024.105536.
[45] Q. Fang, H. Li, X. Luo, L. Ding, H. Luo, T. M. Rose, W. An. Detecting non-hardhat-use by a deep learning method from far-field surveillance videos. Automation in Construction. 85 1-9, 2018. https://doi.org/10.1016/j.autcon.2017.09.018.
[46] J. Li, X. Zhao, G. Zhou, M. Zhang. Standardized use inspection of workers' personal protective equipment based on deep learning. Safety Science. 150 105689, 2022. https://doi.org/10.1016/j.ssci.2022.105689.
[47] H. Luo, J. Liu, W. Fang, P. E. D. Love, Q. Yu, Z. Lu. Real-time smart video surveillance to manage safety: A case study of a transport mega-project. Advanced Engineering Informatics. 45 101100, 2020. https://doi.org/10.1016/j.aei.2020.101100.
[48] Y. Su, C. Mao, R. Jiang, G. Liu, J. Wang. Data-Driven Fire Safety Management at Building Construction Sites: Leveraging CNN. Journal of Management in Engineering. 37 (2): 04020108, 2021. https://doi.org/10.1061/(ASCE) ME.1943-5479.0000877.
[49] Y. G. Lim, J. Wu, Y. M. Goh, J. Tian, V. Gan. Automated classification of “cluttered” construction housekeeping images through supervised and self-supervised feature representation learning. Automation in Construction. 156 105095, 2023. https://doi.org/10.1016/j.autcon.2023.105095.
[50] L. Tan, X. Hu, T. Tang, D. Yuan. A lightweight metro tunnel water leakage identification algorithm via machine vision. Engineering Failure Analysis. 150 107327, 2023. https://doi.org/10.1016/j.engfailanal.2023.107327.
[51] K. W. Johansen, J. Teizer, C. Schultz. Automated rule-based safety inspection and compliance checking of temporary guardrail systems in construction. Automation in Construction. 168 105849, 2024. https://doi.org/10.1016/j.autcon.2024.105849
[52] H. Zhang, D. Cheng, Q. Kou, M. Asad, H. Jiang. Indicative Vision Transformer for end-to-end zero-shot sketch-based image retrieval. Advanced Engineering Informatics. 60 102398, 2024. https://doi.org/10.1016/j.aei.2024.102398.
[53] L. Zhang, J. Wang, Y. Wang, H. Sun, X. Zhao. Automatic construction site hazard identification integrating construction scene graphs with BERT based domain knowledge. Automation in Construction. 142 104535, 2022. https://doi.org/10.1016/j.autcon.2022.104535.
[54] Z. Chen, H. Chen, M. Imani, R. Chen, F. Imani. Vision language model for interpretable and fine-grained detection of safety compliance in diverse workplaces. Expert Systems with Applications. 265 125769, 2025. https://doi.org/10.1016/j.eswa.2024.125769.
[55] S. Wen, M. Park, D. Q. Tran, S. Lee, S. Park. Automated construction safety reporting system integrating deep learning-based real-time advanced detection and visual question answering. Advances in Engineering Software. 198 103779, 2024. https://doi.org/10.1016/j.advengsoft.2024.103779.
[56] H. Pu, X. Yang, J. Li, R. Guo. AutoRepo: A general framework for multimodal LLM-based automated construction reporting. Expert Systems with Applications. 255 124601, 2024. https://doi.org/10.1016/j.eswa.2024.124601.
[57] C. Y. Chang, A. Khanum, H. H. Hsu, M. H. Tsai, W. T. Chen, S. G. Su. Enhancing Daily Reports: Application of Multimodal GPT for Image Description Generation in Construction Site Quality Assurance. 2024 IEEE International Conference on Image Processing Challenges and Workshops (ICIPCW), 2024, pp. 4204-4208. https://doi.org/10.1109/ICIPCW64161.2024.10769129.
[58] P.-C. Lee, J. Wei, H.-I. Ting, T.-P. Lo, D. Long, L.-M. Chang. Dynamic analysis of construction safety risk and visual tracking of key factors based on behavior-based safety and building information modeling. KSCE Journal of Civil Engineering. 23 (10): 4155-4167, 2019. https://doi.org/10.1007/s12205-019-0283-z.
[59] Y. Mao, Y. Ge, Y. Fan, W. Xu, Y. Mi, Z. Hu, Y. Gao. A survey on LoRA of large language models. Frontiers of Computer Science. 19 (7): 197605, 2024. https://doi.org/10.1007/s11704-024-40663-9.
[60] C.-Z. T. Xie, Q. Chen, B. Zhu, E. W. M. Lee, T.-Q. Tang, X. Yin, Z. Yuan, B. Zhang. Coordinating dynamic signage for evacuation guidance: A multi-agent reinforcement learning approach integrating mesoscopic crowd modeling and fire propagation. Chaos, Solitons & Fractals. 194 116246, 2025. https://doi.org/10.1016/j.chaos.2025.116246.
[61] Y. Zhong, H. Jiang, L. Li, R. Nakada, T. Liu, L. Zhang, H. Yao, H. Wang. NEAT: Nonlinear Parameter-efficient Adaptation of Pre-trained Models. arXiv preprint arXiv: 2410.01870. 2024. https://doi.org/10.48550/arXiv.2410.01870.
[62] S. Dou, E. Zhou, Y. Liu, S. Gao, W. Shen, L. Xiong, Y. Zhou, X. Wang, Z. Xi, X. Fan. LoRAMOE: Alleviating world knowledge forgetting in large language models via MoE-style plugin. Proceedings of the 62nd Annual Meeting of the Association for Computational Linguistics (Volume 1: Long Papers), 2024, pp. 1932-1945. https://doi.org/10.18653/v1/2024.acl-long.106.
[63] S. Oh, H. Yang, E. Park. Parameter-Efficient Instance-Adaptive Neural Video Compression. Asian Conference on Computer Vision, 2024. https://doi.org/10.48550/arXiv.2405.08530.
[64] X. L. Li, P. Liang. Prefix-Tuning: Optimizing Continuous Prompts for Generation. Proceedings of the 59th Annual Meeting of the Association for Computational Linguistics and the 11th International Joint Conference on Natural Language Processing (Volume 1: Long Papers), 2021, pp. 4582-4597. https://doi.org/10.18653/v1/2021.acl-long.353.
[65] Y. Song, T. Wang, P. Cai, S. K. Mondal, J. P. Sahoo. A comprehensive survey of few-shot learning: Evolution, applications, challenges, and opportunities. ACM Computing Surveys. 55 (13s): 1-40, 2023. https://doi.org/10.1145/3582688.
[66] M. Ferdous, S. M. M. Ahsan. PPE detector: a YOLO-based architecture to detect personal protective equipment (PPE) for construction sites. PeerJ Computer Science. 8 e999, 2022. https://doi.org/10.7717/peerj-cs.999.
[67] J. Cohen. A Coefficient of Agreement for Nominal Scales. Educational and Psychological Measurement. 20 37-46, 1960. https://doi.org/10.1177/001316446002000104.
[68] Y. Zheng, R. Zhang, J. Zhang, Y. Ye, Z. Luo, Z. Feng, Y. Ma. Llamafactory: Unified efficient fine-tuning of 100+ language models. arXiv preprint arXiv: 2403.13372. 2024. https://doi.org/10.48550/arXiv.2403.13372.
[69] B. Cao, J. Yuan, Y. Liu, J. Li, S. Sun, J. Liu, B. Zhao. SynArtifact: Classifying and Alleviating Artifacts in Synthetic Images via Vision-Language Model. ArXiv. abs/2402.18068, 2024. https://doi.org/10.48550/arXiv.2402.18068.
[70] S. Poddar, P. Koley, J. Misra, N. Ganguly, S. Ghosh. Towards Sustainable NLP: Insights from Benchmarking Inference Energy in Large Language Models. ArXiv. abs/2502.05610, 2025. https://doi.org/10.48550/arXiv.2502.05610.
[71] Y. Zhang, A. Unell, X. Wang, D. Ghosh, Y. Su, L. Schmidt, S. Yeung-Levy. Why are Visually-Grounded Language Models Bad at Image Classification? arXiv preprint arXiv: 2405.18415. 2024. https://doi.org/10.48550/arXiv.2405.18415.
[72] S. Kumar, M. Poyyamozhi, B. Murugesan, N. Rajamanickam, R. Alroobaea, W. Nureldeen. Investigation of Unsafe Construction Site Conditions Using Deep Learning Algorithms Using Unmanned Aerial Vehicles. Sensors. 24 (20): 6737, 2024. https://doi.org/10.3390/s24206737.

The above references are incorporated herein by reference with their entirety.

What is claimed is:

1. A vision-language model (VLM)-based system for end-to-end construction hazard identification and report generation, comprising:
one or more processors;
a VLM-empowered construction hazard identifier supported by the one or more processors and specialized in construction hazard identification; and
a large language model (LLM) supported by the one or more processors and specialized in construction hazard report generation;
one or more memory devices inter-operably coupled with the one or more processors and storing one or more instructions that, when executed by the one or more processors, causes: the VLM-empowered construction hazard identifier to autonomously identify one or more construction hazards in a construction site; and the LLM to generate an end-to-end real-time construction hazard report based on the identified construction hazards;
wherein the VLM-empowered construction hazard identifier is obtained by: constructing a plurality of image-text pairs relevant to construction hazards; designing a plurality of label-alignment prompts based on the image-text pairs; establishing a construction hazard dataset by associating the image-text pairs with the corresponding label-alignment prompts; fine-tuning a plurality of general VLMs using the construction hazard dataset; selecting a best-performing fine-tuned VLM to be the VLM-empowered construction hazard identifier.

2. The vision-language model (VLM)-based system according to claim 1, wherein the plurality of image-text pairs relevant to construction hazards are constructed by:
systematically categorizing a plurality of common construction hazards based on at least one of past literature and practical experience to establish a construction hazard checklist;
collecting a plurality of images from construction sites featuring various hazard characteristics;
classifying the plurality of collected images according to the construction hazard checklist to align each image with one or more construction hazard categories; and
associating each classified image with a corresponding textual description confirming that the image represents at least one construction hazard category to form the plurality of image-text pairs.

3. The vision-language model (VLM)-based system according to claim 2, wherein the plurality of common construction hazards is categorized into four major categories: Personal Protective Equipment (PPE), worker behavior, tools and equipment, and environment.

4. The vision-language model (VLM)-based system according to claim 2, wherein the plurality of label-alignment prompts is designed by: defining a role and expertise of the VLMs to be fine-tuned as an expert in recognizing construction site hazards; specifying input information and output requirements for the VLMs; and listing a plurality of hazard categories according to classified images associated with a plurality of image-text pairs.

5. The vision-language model (VLM)-based system according to claim 1, wherein the general vision-language models (VLMs) have different parameter sizes; and each of the general VLMs is fine-tuned using a low-rank adaption technique without altering parameters of the general VLM.

6. The vision-language model (VLM)-based system according to claim 1, wherein each of the fine-tuned VLMs is evaluated by:
using the fine-tuned VLM to infer outputs on an evaluation dataset;
obtaining alignment results between the inferred outputs with hazard labels; and
calculating evaluation metrics on the obtained alignment results.

7. The vision-language model (VLM)-based system according to claim 1, wherein:
the one or more processors are configured to: receive real-time video footage of the construction site; extract a plurality of image frames from the real-time video footage; and input the plurality of image frames into the VLM-empowered construction hazard identifier;
the VLM-empowered construction hazard identifier is configured to identify the one or more construction hazards in the plurality of image frames;
the one or more processors are further configured to determine the identified hazards corresponding to each point in time and location in the construction site; and
the large language model is configured to: compile all of the identified hazards over a specific period of time; and generate the real-time construction hazard report for the construction site over the specific period of time based on the compiled identified hazards.

8. The vision-language model (VLM)-based system according to claim 7, wherein the plurality of image frames is extracted from the real-time video footage through capturing image frames from the real-time video footage at predetermined time intervals; and associating each captured image frame with a corresponding position and capture time.

9. The vision-language model (VLM)-based system according to claim 8, wherein the one or more construction hazards are identified in the plurality of image frames by: sequentially reading the plurality of image frames; recording the plurality of image frames in a database; and documenting a hazard record for each of the plurality of image frames, wherein the hazard record comprising a location and a timestamp associated with the image frame.

10. The vision-language model (VLM)-based system according to claim 9, wherein the construction hazard report is generated over the specific period of time by:
designing a plurality of report-generation prompts for organizing construction hazard identification results across all locations over the specific period of time, the report-generation prompts including data formats, source explanations, output formats, and considerations for ignoring occasional hazards in a time series;
reading, using the report-generation prompts, a specified length of construction hazard record data from a database, the specified length being determined based on a maximum number of tokens processable by the large language model (LLM);
storing output results generated by the LLM in the database;
repeating the reading and storing steps until all hazard records in the database are organized;
reading, using the report-generation prompts, segmented construction hazard organization results from the database; and
generating the construction hazard report based on the segmented construction hazard organization results.

11. A vision-language model (VLM)-based method for end-to-end construction hazard identification and report generation, comprising:
identifying, by a VLM-empowered construction hazard identifier, one or more hazards in a construction site; and
generating, by a large language model, an end-to-end real-time construction hazard report based on the identified construction hazards;
wherein the VLM-empowered construction hazard identifier is obtained by: constructing a plurality of image-text pairs relevant to construction hazards; designing a plurality of label-alignment prompts based on the image-text pairs; establishing a construction hazard dataset by associating the image-text pairs with the corresponding label-alignment prompts; fine-tuning a plurality of general VLMs using the construction hazard dataset; selecting a best-performing fine-tuned VLM to be the VLM-empowered construction hazard identifier.

12. The vision-language model (VLM)-based method according to claim 11, wherein the plurality of image-text pairs relevant to construction hazards are constructed by:
systematically categorizing a plurality of common construction hazards based on at least one of past literature and practical experience to establish a construction hazard checklist;
collecting a plurality of images from construction sites featuring various hazard characteristics;
classifying the plurality of collected images according to the construction hazard checklist to align each image with one or more construction hazard categories; and
associating each classified image with a corresponding textual description confirming that the image represents at least one construction hazard category to form the plurality of image-text pairs.

13. The vision-language model (VLM)-based method according to claim 12, wherein the plurality of common construction hazards is categorized into four major categories: Personal Protective Equipment (PPE), worker behavior, tools and equipment, and environment.

14. The vision-language model (VLM)-based method according to claim 12, wherein the plurality of label-alignment prompts is designed by: defining a role and expertise of the VLMs to be fine-tuned as an expert in recognizing construction site hazards; specifying input information and output requirements for the VLMs; and listing a plurality of hazard categories according to classified images associated with a plurality of image-text pairs.

15. The vision-language model (VLM)-based method according to claim 11, wherein the general vision-language models (VLMs) have different parameter sizes; and each of the general VLMs is fine-tuned using a low-rank adaption technique without altering parameters of the general VLM.

16. The vision-language model (VLM)-based method according to claim 11, wherein each of the fine-tuned vision-language models (VLMs) is evaluated by:
using the fine-tuned VLM to infer outputs on an evaluation dataset;
obtaining alignment results between the inferred outputs with hazard labels; and
calculating evaluation metrics on the obtained alignment results.

17. The vision-language model (VLM)-based method according to claim 11, further comprising:
receiving real-time video footage of the construction site;
extracting a plurality of image frames from the real-time video footage;
inputting the plurality of image frames into the VLM-empowered construction hazard identifier;
identifying the one or more construction hazards in the plurality of image frames;
determining the identified hazards corresponding to each point in time and location in the construction site;
compiling all of the identified hazards over a specific period of time; and
generating the real-time construction hazard report for the construction site over the specific period of time based on the compiled identified hazards.

18. The vision-language model (VLM)-based method according to claim 17, wherein the plurality of image frames is extracted from the real-time video footage through capturing image frames from the real-time video footage at predetermined time intervals; and associating each captured image frame with a corresponding position and capture time.

19. The vision-language model (VLM)-based method according to claim 18, wherein the one or more construction hazards are identified in the plurality of image frames by: sequentially reading the plurality of image frames; recording the plurality of image frames in a database; and documenting a hazard record for each of the plurality of image frames, wherein the hazard record comprising a location and a timestamp associated with the image frame.

20. The vision-language model (VLM)-based method according to claim 19, wherein the construction hazard report is generated over the specific period of time by:
designing a plurality of report-generation prompts for organizing construction hazard identification results across all locations over the specific period of time, the report-generation prompts including data formats, source explanations, output formats, and considerations for ignoring occasional hazards in a time series;
reading, using the report-generation prompts, a specified length of construction hazard record data from a database, the specified length being determined based on a maximum number of tokens processable by the large language model (LLM);
storing output results generated by the LLM in the database;
repeating the reading and storing steps until all hazard records in the database are organized;
reading, using the report-generation prompts, segmented construction hazard organization results from the database; and
generating the construction hazard report based on the segmented construction hazard organization results.
